(19) United States
(12) Patent Application Publication
(10) Pub. No.: US 2004/0257592 A1
(43) Pub. Date: Dec. 23, 2004

(54) Scanning method and device for performing gamma corrections according to multiple gamma functions

(76) Inventors: Hai-Jui Lin, Yun-Lin Hsien (TW); Hsing-Hung Lin, Hsin-Chu City (TW)

Correspondence Address: BIRCH STEWART KOLASCH & BIRCH, PO BOX 747, FALLS CHURCH, VA, 22040-0747, US

(21) Appl. No.: 10/778,101

(22) Filed: Feb. 17, 2004

(30) Foreign Application Priority Data
Jun. 17, 2003 (TW) 092116460

(51) Int. Cl. G06F 3/05; H04N 1/407; H04N 1/04

(52) U.S. Cl. 358/1.6; 358/474; 358/406

(57) ABSTRACT

A scanning method for performing gamma corrections according to multiple gamma functions includes the steps of: scanning a document using a plurality of sensing member sets to obtain plural sets of front image signals, each sensing member set including a plurality of sensing members to sense light rays of the same color at the same time; loading a plurality of gamma functions, which corresponds to each sensing member set, from a memory; and correcting the plural sets of front image signals into plural sets of post image signals according to the gamma functions. The invention also provides a scanning device using the scanning method.

### BACKGROUND OF THE INVENTION

1. Field of the Invention

The invention relates to a scanning method and a scanning device, and more particularly to a scanning method and a scanning device for performing gamma corrections according to multiple gamma functions.

2. Description of the Related Art

Recently, a conventional scanning device cannot satisfy the user's increasing demands on the scanning quality. An image signal received by a CCD or a CIS image sensor of the scanning device must be applied with white corrections or calibrations and dark corrections or calibrations, and then subsequently with gamma corrections to obtain a real image signal.

The conventional scanning device usually has one image sensor, which includes red, green, blue and/or black-and-white sensing member sets. As for the image signals acquired by the sensing member sets for sensing light rays of the same color, the gamma corrections are performed using the gamma curves corresponding to the sensing member sets for sensing the light rays of the same color.

The above-mentioned image sensor may be a staggered-type image sensor. The staggered-type image sensor has two sensing member sets arranged in parallel to sense image signals of the same color. Sensing members of the two sensing member sets are staggered such that a first sensing member set senses an odd-numbered set of image signals, and a second sensing member set senses an even-numbered set of image signals.

FIG. 1 shows a standard pattern for correcting gray-scale levels for an image. Referring to FIG. 1, the standard pattern 100 has six blocks P1 to P6 having correction patterns with different gray-scale values (brightness). For example, the gray-scale values of the blocks P1 to P6 gradually increase. The image sensor senses this standard pattern 100 to obtain actual signals. The gamma function corresponding to the gamma curve of the image sensor may be derived according to the actual signals and standard signals of the correction pattern.

FIG. 2 is a graph showing the relationship between the brightnesses and blocks by curves generated after using two image sensors to sense the standard pattern of FIG. 1. As shown in FIG. 2, a horizontal axis represents blocks P1 to P6, a vertical axis represents the brightnesses, a curve 110 corresponds to a sensed result of a first sensing member set, a curve 120 corresponds to a sensed result of a second sensing member set, and a curve 130 corresponds to the actual property of the standard pattern 100.

Owing to the manufacturing errors and the properties of the image sensor itself, the first and second sensing member sets are different to make the curves 110 and 120 deviate from the curve 130. More particularly, if the two sensing member sets are not manufactured in the same manufacturing process, the resulted difference is more obvious.

FIG. 3 shows sensed results of the two image sensors. As shown in FIG. 3, two fragment patterns 140 and 150 with different brightnesses are produced by using the first and second sensing member sets to scan a pattern with the same gray-scale level.

In the above-mentioned staggered-type image sensor, the images obtained by the two sensing member sets are different. Furthermore, the high demands on the scanning quality in this invention are not proposed according to the design rule of the prior art scanning device, so the prior art gamma corrections are performed according to one of the sensing member sets. Consequently, the odd-numbered image signals tend to be different from the even-numbered image signal, and the difference cannot be accepted by some professionals cared by this invention.

### SUMMARY OF THE INVENTION

It is therefore an object of this invention to provide a scanning method for performing gamma corrections according to multiple gamma functions capable of reducing the influence of the manufacturing errors on the scanning quality, enhancing the scanning quality of a scanning device, and satisfying the demands of various users, and the scanning device using this method.

To achieve the above-mentioned object, the invention provides a scanning method for performing gamma corrections according to multiple gamma functions. The method includes the steps of: scanning a document using a plurality of sensing member sets to obtain plural sets of front image signals, each sensing member set including a plurality of sensing members to sense light rays of the same color at the same time; loading a plurality of gamma functions, which corresponds to each sensing member set, from a memory; and correcting the plural sets of front image signals into plural sets of post image signals according to the gamma functions.

To achieve the above-mentioned object, the invention also provides a scanning device for performing gamma corrections according to multiple gamma functions. The scanning device includes a plurality of sensing member sets, a memory and a processing circuit. The sensing member sets scan a document to obtain plural sets of front image signals. Each of the sensing member sets includes a plurality of sensing members for sensing light rays of the same color at the same time point. The memory stores a plurality of gamma functions corresponding to each of the sensing member sets. The processing circuit corrects the plural sets of front image signals to generate plural sets of post image signals according to the gamma functions.

Using multiple gamma functions to perform the gamma corrections may effective eliminate the influence of ununiformity among or between different sensing member sets.

### BRIEF DESCRIPTION OF THE DRAWINGS

FIG. 1 shows a standard pattern for correcting gray-scale levels for an image.

FIG. 2 is a graph showing the relationship between the brightnesses and blocks by curves generated after using two image sensors to sense the standard pattern of FIG. 1.

FIG. 3 shows sensed results of the two image sensors.

FIG. 4 is a flow chart showing a scanning method for performing gamma corrections according to multiple gamma functions.

FIG. 5 is a schematic illustration showing a scanning device according to a first embodiment of the invention.

FIG. 6 is a schematic illustration showing a scanning device according to a second embodiment of the invention.

FIG. 7 is a schematic illustration showing a scanning device according to a third embodiment of the invention.

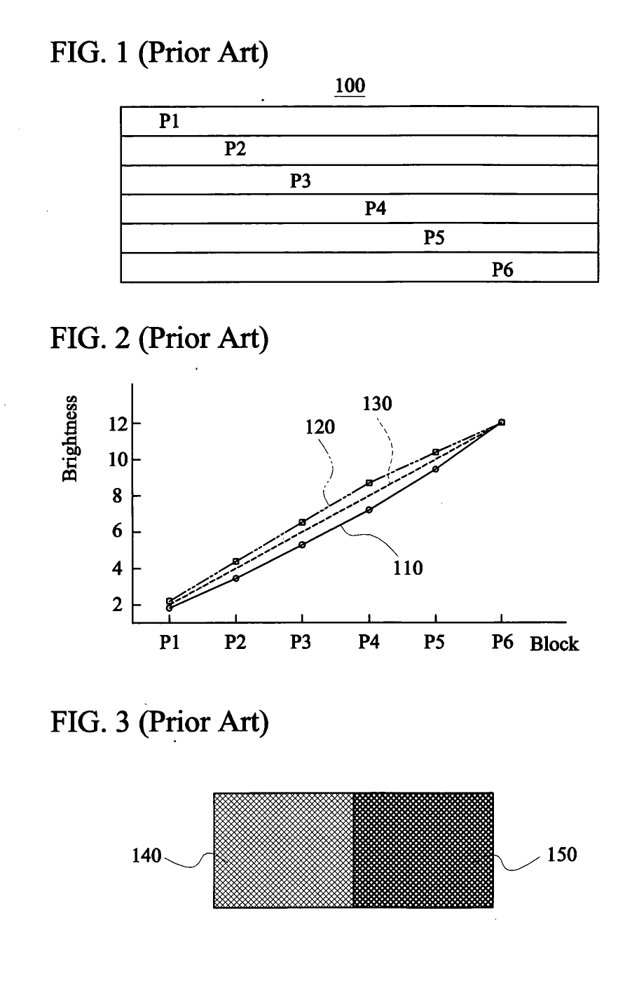

### DETAILED DESCRIPTION OF THE INVENTION

The invention also utilizes the above-mentioned standard pattern 100 to generate the gamma functions. It is to be noted that the number of section blocks of the standard pattern 100 may be adjusted according to the actual demands, and is not limited to six.

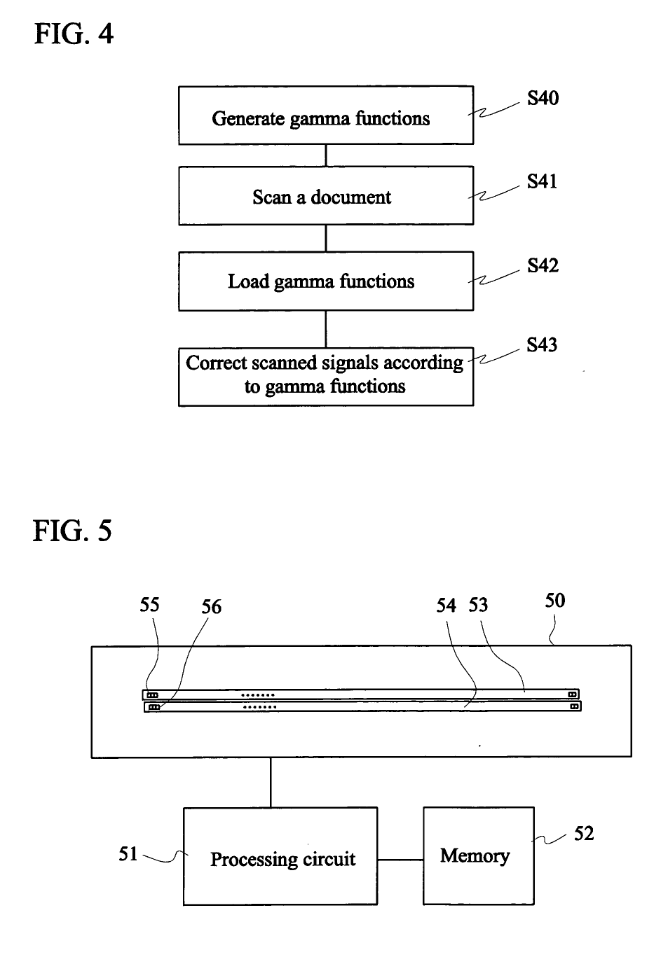

FIG. 4 is a flow chart showing a scanning method for performing gamma corrections according to multiple gamma functions. As shown in FIG. 4, the scanning method includes the following steps.

In step S40, a plurality of gamma functions is generated. In this step, a plurality of correction patterns with different gray-scale levels is scanned by a plurality of sensing member sets to obtain a plurality of analog correction signals. Next, the analog correction signals are converted into a plurality of digital correction signals. Then, the gamma functions corresponding to the sensing member sets are derived with reference to the correction patterns and the digital correction signals. The gamma functions, which serve as bases for the gamma corrections, may be stored in a memory of the scanning device.

In step S41, a document is scanned by the plurality of sensing member sets to obtain plural sets of front image signals. Each of the sensing member sets includes a plurality of sensing members to sense light rays of the same color.

In step S42, the gamma functions corresponding to the sensing member sets are loaded from the memory.

In step S43, the plural sets of front image signals are corrected and hence transformed into plural sets of post image signals according to the gamma functions. The post image signals truly correspond to the scanned document image.

In the prior art, it is considered that the properties of the sensing member sets are the same, and thus the gamma functions of the sensing member sets are also the same. So, only the gamma function of one of the sensing member sets serves as the basis for correcting the signals sensed by all of the sensing member sets. Consequently, the prior art cannot satisfy the demand of high scanning quality. In contrast, the above-mentioned method of the invention utilizes the different gamma functions of the sensing member sets as bases for correcting the signals sensed by the sensing member sets. So, the signals sensed by each of the sensing member sets are corrected according to the properties of each of the sensing member sets so that the image of the to-be-scanned document may be truly reproduced. It is to be noted that the step S40 may be performed before the scanning device is packaged in the factory. In this case, the scanning device only has to perform the steps S41 to S43 to scan the documents.

The scanning device of the invention utilizing the above-mentioned method will be described in the following.

FIG. 5 is a schematic illustration showing a scanning device according to a first embodiment of the invention. As shown in FIG. 5, the scanning device of the first embodiment includes an image sensor 50, a processing circuit 51 and a memory 52. The image sensor 50 includes two sensing member sets 53 and 54 for scanning a document to obtain plural sets of front image signals. The sensing member set 53 includes a plurality of sensing members 55, the sensing member set 54 includes a plurality of sensing members 56, and each of the sensing members 55 and 56 is used to sense and to generate light rays of the same color at the same time. For example, the sensing members 55 and 56 are used to sense black-and-white, red, green, or blue light rays. It is to be noted that the image sensor 50 may include four sets of sensing member sets 53 and 54 for sensing black-and-white, red, green, and blue light rays, or three sets of sensing member sets 53 and 54 for sensing red, green, and blue light rays, such that the scanning device may perform the color scanning.

In this embodiment, the sensing members 55 and 56 are arranged in a staggered manner and in two straight lines. The front image signals sensed by the sensing members 55 are odd-numbered sets of image signals, while the front image signals sensed by the sensing members 56 are even-numbered sets of image signals. Staggering the even-numbered sets of image signals with the odd-numbered sets of image signals may obtain image signals of a scan line.

The memory 52 is used to store a plurality of gamma functions corresponding to the sensing member sets 53 and 54. The processing circuit 51 corrects the plural sets of front image signals into plural sets of post image signals according to the gamma functions. The plurality of gamma functions may be obtained through the processing circuit 51 and the step S40 mentioned in FIG. 4, and may be stored in the memory 52.

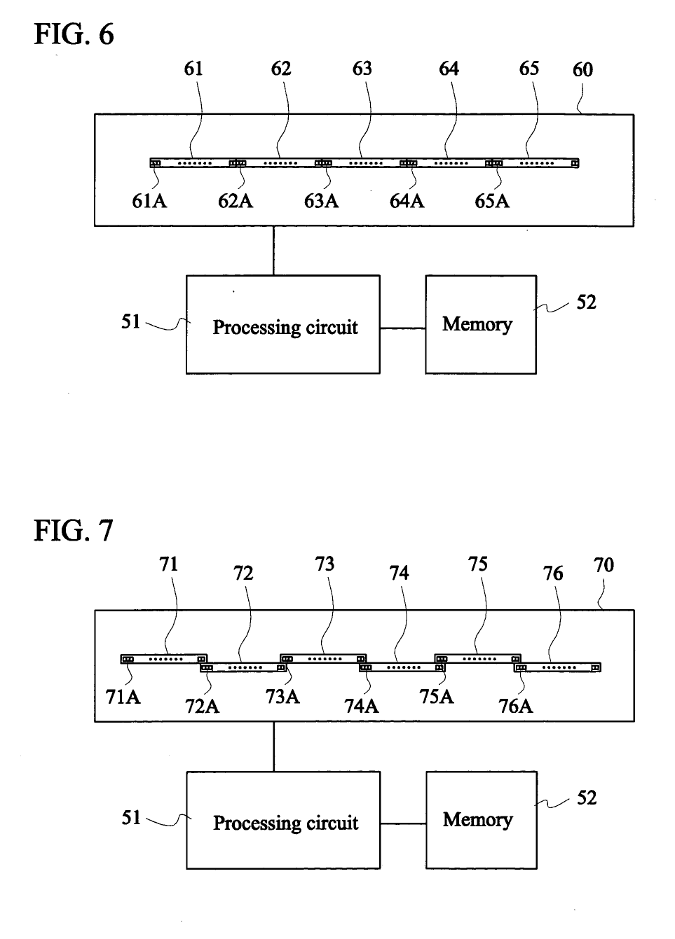

FIG. 6 is a schematic illustration showing a scanning device according to a second embodiment of the invention. As shown in FIG. 6, the scanning device of this embodiment is similar to that of the first embodiment, but differs from the first embodiment in that the image sensor 60 of this embodiment includes a plurality of sensing member sets 61 to 65 having plural sensing members 61A to 65A arranged in a straight line. The sensing member sets 61 to 65 may be manufactured under different manufacturing processes and then packaged into the image sensor 60. In this case, the properties of the sensing member sets 61 to 65 may be slightly different from one other. The image signals sensed by the sensing member sets 61 to 65 are gamma-corrected according to their corresponding gamma functions, respectively. It is to be noted that the image sensor 60 may also include three or four sets of sensing member sets 61 to 65 to sense red, blue, green and black-and-white light rays.

Although the above-mentioned sensing member sets 61 to 65 are of CCD (charge coupled device) sensing member sets having a plurality of sensing members for sensing light rays of the same color, the sensing member sets 61 to 65 may be of contact image sensor (CIS) sensing member sets in other embodiments. When the sensing member sets 61 to 65 are CIS sensing member sets, the sensing members 61A to 65A alternatively sense light rays having at least three different colors. However, the sensing members 61A to 65A sense the light rays of the same color at the same time point. At this time, each of the sensing member sets 61 to 65 may have the gamma functions corresponding to red, green, blue light rays for correction, may have the gamma function corresponding to white light rays for correction, or may have the gamma functions corresponding to red, green, blue, and white light rays for correction.

In an alternative embodiment, the sensing member sets 61 to 65 may be staggered sensing member sets, each of which is similar to the combination of the staggered sensing member sets 53 and 54 of FIG. 5. In this case, the sensing members of the sensing member sets 61 to 65 are arranged in two straight lines, and the sensing member sets 61 to 65 have different gamma functions.

FIG. 7 is a schematic illustration showing a scanning device according to a third embodiment of the invention. As shown in FIG. 7, the scanning device of this embodiment is similar to that of the first embodiment, but differs from the first embodiment in that the image sensor 70 of this embodiment includes a plurality of sensing member sets 71 to 76 having plural sensing members 71A to 76A arranged in two straight lines. The sensing member sets 71 to 76 may be manufactured in different manufacturing processes and then packaged into the image sensor 70. In this case, the properties of the sensing member sets 71 to 76 may be slightly different from one another. The image signals sensed by the sensing member sets 71 to 76 are gamma-corrected according to their corresponding gamma functions, respectively. It is to be noted that the image sensor 70 may also include three or four sets of sensing member sets 71 to 76 to sense red, blue, green and black-and-white light rays.

In an alternative embodiment, the sensing member sets 71 to 76 may be staggered sensing member sets, each of which is similar to the combination of the staggered sensing member sets 53 and 54 of FIG. 5. In this case, the sensing member sets 71 to 76 have different gamma functions, the sensing members of the sensing member sets 71 to 76 are arranged in four straight lines, and the sensing members on the same straight line generate the front image signals corresponding to the same scan line.

Each of the gamma correction functions corresponding to each of the sensing member sets may depend on the average property of all of the sensing members, the property of a single sensing member, or the properties of all of the sensing members. Of course, it is preferred that the signals sensed by each sensing member are corrected according to its own gamma function.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A scanning method for performing gamma corrections according to multiple gamma functions, comprising the steps of:
scanning a document using a plurality of sensing member sets to obtain plural sets of front image signals, wherein each of the sensing member sets comprises a plurality of sensing members which sense light rays of the same color at the same time;
loading a plurality of gamma functions, which corresponds to each of the sensing member sets, from a memory; and
correcting the plural sets of front image signals according to the gamma functions, and hence transforming the plural sets of front image signals into plural sets of post image signals.

2. The scanning method according to claim 1, further comprising the steps of:
obtaining a plurality of analog correction signals by scanning a plurality of correction patterns of different gray scale levels with the sensing member sets;
converting the analog correction signals into a plurality of digital correction signals; and
deriving the gamma functions with reference to the correction patterns and the digital correction signals.

3. The scanning method according to claim 1, wherein the sensing member sets are staggered sensing member sets, and the sensing members of the sensing member sets are arranged in two straight lines.

4. The scanning method according to claim 1, wherein the sensing members of the sensing member sets are arranged in a straight line.

5. The scanning method according to claim 1, wherein the sensing member sets are staggered sensing member sets arranged in two straight lines, and the sensing members of the sensing member sets are arranged in four straight lines.

6. The scanning method according to claim 1, wherein the sensing members of the sensing member sets are arranged in two straight lines, and the sensing members on the same straight line generate the front image signals corresponding to the same scan line.

7. The scanning method according to claim 1, wherein the sensing member sets are staggered sensing member sets arranged in one straight line, the sensing members of the sensing member sets are arranged in two straight lines, and the sensing members on the same straight line generate the front image signals corresponding to the same scan line.

8. A scanning device for performing gamma corrections according to multiple gamma functions, the scanning device comprising:
a plurality of sensing member sets for scanning a document and obtaining plural sets of front image signals, wherein each of the sensing member sets comprises a plurality of sensing members which at the same time sense light rays of same color;
a memory for storing a plurality of gamma functions corresponding to each of the sensing member sets; and
a processing circuit for correcting the plural sets of front image signals according to the gamma functions and therefore transforming the plural sets of front image signals into plural sets of post image signals.

9. The scanning device according to claim 8, wherein the sensing member sets are staggered sensing member sets, and the sensing members of the sensing member sets are arranged in two straight lines.

10. The scanning device according to claim 8, wherein the sensing members of the sensing member sets are arranged in a straight line.

11. The scanning device according to claim 8, wherein the sensing member sets are staggered sensing member sets arranged in two straight lines, and the sensing members of the sensing member sets are arranged in four straight lines.

12. The scanning device according to claim 8, wherein the sensing members of the sensing member sets are arranged in two straight line, and the sensing members on the same straight line generate the front image signals corresponding to the same scan line.

13. The scanning method according to claim 8, wherein the sensing member sets are staggered sensing member sets arranged in one straight line, the sensing members of the sensing member sets are arranged in two straight lines, and the sensing members on the same straight line generate the front image signals corresponding to the same scan line.

14. The scanning device according to claim 8, wherein the sensing member sets are charge coupled device (CCD) sensing member sets.

15. The scanning device according to claim 8, wherein the sensing member sets are contact image sensor (CIS) sensing member sets.
